(19) United States
(12) Patent Application Publication
(10) Pub. No.: US 2026/0370312 A1
(43) Pub. Date: Nov. 19, 2026

(54) METHODS AND SYSTEMS FOR POWER CONTROL FOR SATELLITE TERMINALS

(71) Applicant: Hughes Network Systems, LLC, Germantown, MD (US)

(72) Inventors: Peter Lin, North Potomac, MD (US); Yeqing Tang, North Potomac, MD (US); John Border, Middletown, MD (US); Robert James Torres, New Market, MD (US)

(21) Appl. No.: 19/671,652

(22) Filed: May 8, 2026

Related U.S. Application Data
(60) Provisional application No. 63/802,552, filed on May 8, 2025.

(51) Int. Cl. H04B 7/185

(52) U.S. Cl. CPC H04B 7/18513; H04B 7/18519; H04B 7/1858

(57) ABSTRACT

Methods and systems for curve fitting power calibration for satellite terminals include storing ranging curve data indicating relative performance of the communication device for a plurality of combinations of symbol rates and modulation types, performing a ranging process to determine a first performance measure for the satellite terminal for a first combination of symbol rate and modulation type, calculating a second performance measure for the satellite terminal for a second combination of symbol rate and modulation type, the second combination being different from the first combination, wherein the second performance measure is calculated based on the first performance measure and the data for the ranging curve, determine a power level for transmission by the satellite terminal at the second combination based on the second performance measure, and transmitting data in a satellite communication network at the second combination using the power level as determined.

### CROSS REFERENCE TO RELATED APPLICATIONS

This application claims priority to U.S. Provisional Patent Application No. 63/802,552, filed on May 8, 2025, the disclosure of which is incorporated by reference in its entirety for all purposes.

### BACKGROUND

Satellite communication systems require precise control over the transmission power of satellite terminals to maintain a consistent signal-to-noise ratio (SNR) at a terrestrial gateway. Proper power level management is essential to ensuring that packet error rates remain stable across varying network conditions. For example, closed loop power control (CLPC) may be implemented at the satellite terminal to address any terminal uplink tower that may be required to maintain a certain SNR at the gateway to ensure the packet error rate remains steady.

To establish the initial transmit power necessary to achieve these target metrics, terminals typically undergo a ranging or power calibration process. This initial transmit power is generally used as the power required to achieve the target SNR by CLPC.

A traditional ranging process may involve the terminal transmitting a preset number (e.g., fifty) bursts of data transmission, measuring a SNR value for each burst received and decoded at a gateway (GW), and tracking the transmitted power and SNR values over the number of bursts. The ranging process is generally executed for each combination of symbol rate, modulation type, and code rate (also referred to as Symcod), thus can be highly resource-, bandwidth-, and time-intensive. Further, as the ranging process generally requires the terminal to transmit data at maximum power, adjacent channel interference (ACI) effects may affect the measured ranging results. Such difficulties are compounded when multiple terminals undergo a ranging process at once.

Furthermore, the relationship between transmission power and signal quality across different terminal hardware configurations is often nonlinear. While simplified estimation techniques have been used to approximate the power requirements for different transmission rates, these linear approximations frequently lead to inaccuracies, particularly when estimating across different modulation types. Such inaccuracies can result in either an overuse or underuse of terminal power, which may lead to increased ACI, elevated packet error rates, and/or loss of data integrity. Additionally, environmental factors such as varying atmospheric attenuation and changes in the noise floor at the gateway further complicate the ability of a terminal to maintain optimal power settings without frequent and costly re-ranging events.

### SUMMARY

The present disclosure relates generally to satellite communication networks and, more particularly, to techniques for improving the accuracy and efficiency of power control for satellite terminals.

In embodiments, a method of controlling transmission power of a satellite terminal includes storing, by the satellite terminal, ranging curve data indicating relative performance of the satellite terminal for a plurality of combinations of symbol rates and modulation types. The method further includes performing, by the satellite terminal, a ranging process to determine a first performance measure for the satellite terminal for a first combination of symbol rate and modulation type. The method further includes calculating, by the satellite terminal, a second performance measure for the satellite terminal for a second combination of symbol rate and modulation type, the second combination being different from the first combination. Calculating the second performance measure includes calculation based on the first performance measure and the data for the ranging curve. The method further includes determining, by the satellite terminal, a power level for transmission by the satellite terminal at the second combination based on the second performance measure. The method includes further transmitting, by the satellite terminal, data in a satellite communication network at the second combination using the power level as determined.

In embodiments, the ranging curve data is based on power calibration measurements that indicate measured characteristics of one or more of a radio and a cable of the satellite terminal. When the ranging curve exhibits nonlinear behavior, calculating the second performance measure further includes using the ranging curve data in compensating for the nonlinear behavior. The ranging curve data may be based on results of ranging performed by the satellite terminal for each one of a plurality of combinations of symbol rates and modulation types. The ranging is performed over time across a plurality of sessions of use for one or more of the plurality of combinations. The method further includes storing, by the satellite terminal, an atmospheric data table that relates atmospheric attenuation levels with a plurality of performance measures for the satellite terminal. In embodiments, determining the power level further includes considering the atmospheric data table. In embodiments, the atmospheric data table includes indications of a plurality of levels of signal quality and corresponding levels of atmospheric attenuation for the first combination and the second combination. Calculating the second performance measure may include determining a specific level of atmospheric attenuation based on the first performance measure and the atmospheric data table. In embodiments, calculating the second performance measure includes using the specific level of atmospheric attenuation and the atmospheric data table to determine the second performance measure. The method includes measuring a signal quality of data transmission from the satellite terminal at one or more time points. The method includes updating the atmospheric data table based on the signal quality as measured at the one or more time points. The method includes determining additional performance measures of the satellite terminal for transmission outside of the ranging process. The method includes updating the ranging curve data based on the additional performance measures. In embodiments, the additional performance measures include transmission characteristics obtained using a transmission power level that is less than a full power level of a radio of the satellite terminal. In embodiments, determining the power level includes using a controller based on one or more parameters determined using a machine learning model. In embodiments, the controller is one of a proportional-integral (PI) controller and a proportional-integral-derivative (PID) controller. In embodiments, the one or more parameters for the controller are determined using reinforcement learning.

In embodiments, a satellite terminal includes a transmitter. The satellite terminal includes a data storage device storing ranging curve data indicating relative performance of the satellite terminal for a plurality of combinations of symbol rates and modulation types. The satellite terminal includes a control system including one or more processors and one or more machine-readable media storing executable instructions. In embodiments, the executable instructions cause the satellite terminal to perform a ranging process to determine a first performance measure for the satellite terminal for a first combination of symbol rate and modulation type. In embodiments, the executable instructions cause the satellite terminal to calculate a second performance measure for the satellite terminal for a second combination of symbol rate and modulation type, the second combination being different from the first combination. In embodiments, the second performance measure calculation is based on the first performance measure and the data for the ranging curve. In embodiments, the executable instructions cause the satellite terminal to determine a power level for transmission by the satellite terminal at the second combination based on the second performance measure. In embodiments, the executable instructions cause the satellite terminal to transmit data in a satellite communication network at the second combination using the power level as determined.

In embodiments, the ranging curve data is based on power calibration measurements that indicate measured characteristics of one or more of a radio and a cable of the satellite terminal. In embodiments, if the ranging curve exhibits nonlinear behavior, then calculating the second performance measure further includes using the ranging curve data in compensating for the nonlinear behavior. In embodiments, the ranging curve data is based on results of ranging performed by the satellite terminal for each one of a plurality of combinations of symbol rates and modulation types. In embodiments, the ranging is performed over time across a plurality of sessions of use for one or more of the plurality of combinations. In embodiments, the executable instructions further cause the satellite terminal to store an atmospheric data table that relates atmospheric attenuation levels with a plurality of performance measures for the satellite terminal. In embodiments, determining the power level further includes considering the atmospheric data table. In embodiments, the atmospheric data table includes indications of a plurality of levels of signal quality and corresponding levels of atmospheric attenuation for the first combination and the second combination. In embodiments, calculating the second performance measure includes determining a specific level of atmospheric attenuation based on the first performance measure and the atmospheric data table. In embodiments, the second performance measure includes using the determined level of atmospheric attenuation and the atmospheric data table to determine the second performance measure. In embodiments, the executable instructions further cause the satellite terminal to measure a signal quality of data transmission from the satellite terminal at one or more time points. In embodiments, if signal quality is measured, then the satellite terminal updates the atmospheric data table based on the signal quality as measured at the one or more time points. In embodiments, the executable instructions further cause the satellite terminal to determine additional performance measures of the satellite terminal for transmission outside of the ranging process. In embodiments, the executable instructions further cause the satellite terminal to update the ranging curve data based on the additional performance measures. In embodiments, additional performance measures include transmission characteristics obtained using a transmission power level that is less than a full power level of a radio of the satellite terminal. In embodiments, determining the power level includes using one of a proportional-integral (PI) controller and a proportional-integral-derivative (PID) controller based on one or more parameters determined using a machine learning model.

In embodiments, one or more non-transitory machine-readable media store executable instructions that, when executed by one or more processors of a communication device, cause the communication device to store ranging curve data indicating relative performance of the communication device for a plurality of combinations of symbol rates and modulation types. In embodiments, the executable instructions cause the communication device to perform a ranging process to determine a first performance measure for the satellite terminal for a first combination of symbol rate and modulation type. In embodiments, the executable instructions cause the communication device to calculate a second performance measure for the satellite terminal for a second combination of symbol rate and modulation type, the second combination being different from the first combination. In embodiments, calculating the second performance measure is based on the first performance measure and the data for the ranging curve. In embodiments, the executable instructions cause the communication device to determine a power level for transmission by the satellite terminal at the second combination based on the second performance measure. In embodiments, the executable instructions cause the communication device to transmit data in a satellite communication network at the second combination using the power level as determined.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram showing an example of a satellite communication system with power control for satellite terminals, in accordance with embodiments.

FIG. 2 is a flowchart illustrating a power control method for satellite terminals, in accordance with embodiments.

FIG. 3 is a flowchart illustrating a portion of the power control method of FIG. 2, in accordance with embodiments.

FIG. 4 are graphs illustrating measured cable noise density ratio (C/N_{O}) values and energy per symbol to noise density ratio (E_{S}/N_{O}) as a function of symbol rate index, modulation index, and code rate index (SMC) values over a variety of combinations of symbol rates, modulation types, and forward error correction code rates.

FIG. 5 is a graph illustrating an example of error that can result from power estimation without curve fitting or other techniques discussed herein.

FIGS. 6A and 6B are graphs illustrating examples of ranging curves and curve fitting for several different satellite terminals. In particular, FIG. 6A shows a comparison of ranging curves for seven different satellite terminals at ten Symcod rates.

FIG. 6B shows the differences in the ranging curves for the seven different satellite terminals, when the ranging curves of FIG. 6A are shifted to an arbitrary origin for comparison.

FIG. 7 is a table showing an example of target signal quality measures and other characteristics for a variety of modulation types and code rates, in accordance with embodiments.

FIG. 8 is a table showing an example of information in calibration files suitable for use in generating the initial ranging curve of a satellite terminal, in accordance with embodiments.

FIGS. 9A-9C are diagrams illustrating aspects example techniques for detecting and accounting for atmospheric attenuation, in accordance with embodiments. In particular, FIG. 9A shows a graph illustrating shifts in the maximum energy per symbol to noise power spectral density ratio (E_{S}/N_{O}) and ranged attenuation in the presence of atmospheric conditions.

FIG. 9B is a block diagram illustrating a process of consulting an atmospheric attenuation table in order to generate an atmospheric attenuation level, in accordance with embodiments.

FIG. 9C is an example atmospheric attenuation table, in accordance with embodiments.

FIG. 10 is a block diagram illustrating an example of techniques that can be used for power control in satellite terminals, in accordance with embodiments.

FIG. 11 is a block diagram illustrating an example of techniques for using information about transmissions made by a satellite terminal to create or update a ranging curve, in accordance with embodiments.

Like reference numbers and designations in the various drawings indicate like elements.

### DETAILED DESCRIPTION

The techniques disclosed herein provide systems and methods for managing the transmission power of satellite terminals by using an enhanced power control process. The improved techniques may be implemented at satellite terminals, thus no modification at the gateway is needed.

The use of a single rate ranging (SRR) process within the satellite terminal power control procedure reduces the number of ranging events needed by using the actual ranging results of the most robust rate to estimate all other rates in a trajectory table. For example, rather than requiring a terminal to undergo a long and power-intensive testing process for every possible combination of symbol rates and modulation types, the terminal can perform a single ranging procedure for one Symcod rate, and the resulting ranging curve may be used to estimate required power for all other Symcod combinations. However, during the extrapolation to Symcod combinations other than the one used to perform the SRR, inaccuracies may occur.

To counter possible inaccuracies, additional enhancements are described herein to further improve the SRR implementation. The additional enhancements disclosed herein include: 1) SRR with improved curve-fitting methods; 2) considering ranging data accumulated over time; 3) accounting for atmospheric attenuation in the curve fitting; 4) Just-in-Time (JIT) ranging implementation; and 5) adaptive power control with machine learning techniques.

In particular, an improved curve fitting process is used to tailor the SRR result to the unique hardware combination characteristics of each terminal. The curve fitting method is further enhanced by taking into consideration the nonlinear behavior of the required power settings.

Further, the curve fitting method may be further improved by considering ranging data accumulated over time. That is, the curve fitting method may be updated and refined while the terminal is deployed in the field by using historical data and the success rates of regular data transmissions.

Additionally, historical ranging data obtained under various weather conditions may be used in refining the curve fitting method. For example, the previously obtained ranging data may be used to define a modification parameter for accounting for free space loss or atmospheric attenuation levels for a given weather condition, thus eliminating the need to implement re-ranging procedures when weather conditions change.

Just-in-Time ranging relates to the implementation of specific criteria for triggering a re-ranging process, such that re-ranging is not performed unnecessarily and reducing the bandwidth, time, and power requirements for re-ranging. That is, the ranging data, including relevant information such as transmitting power attenuation (“txAtten”) and CLPC output (“powerAdj”), may be updated as without actually performing a re-ranging process, given certain specific criteria are met.

Finally, the power control process itself may be auto-tuned by machine learning techniques to adapt to actual use conditions. In this way, the CLPC output powerAdj may be more accurate and responsive to specific use conditions. All of these enhancements are described in further detail hereinafter.

The presently described approach offers a significant technical improvement over existing technologies that typically rely on linear approximations to estimate power needs. Existing methods fail to account for the actual nonlinear behavior of the terminal components, such as the radio (i.e., the transceiver). By moving beyond simple linear models to a multi-segment curve fitting algorithm, the resulting terminal achieves much higher accuracy, preventing the common problems of using too much power, which causes interference for other users, or too little power, which leads to high error rates and lost data. In this way, the techniques disclosed herein reduce the computational time and bandwidth required in traditional calibration, minimizes network interference effects such as ACI, and ensures more reliable communication in a wide range of environmental conditions.

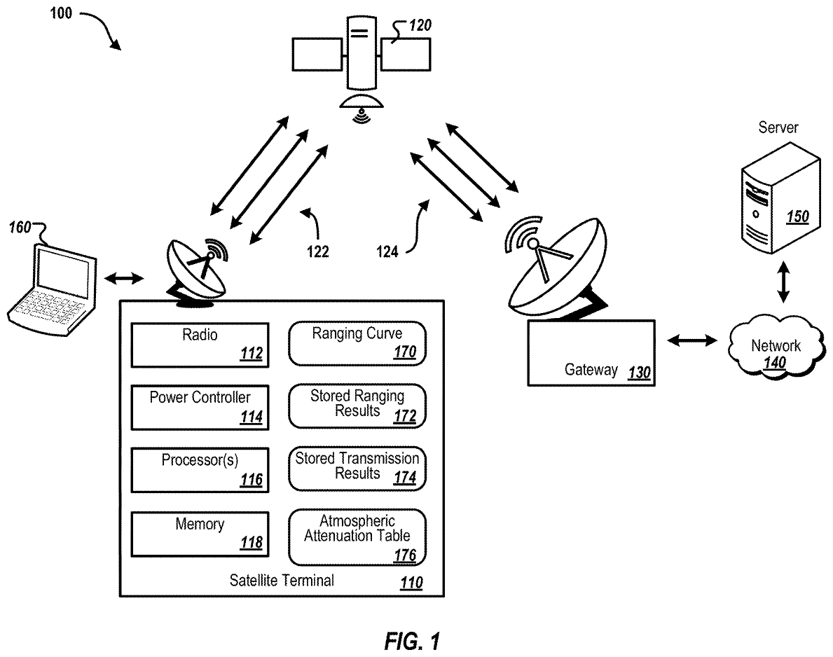

Turning now to the drawings, FIG. 1 is a block diagram showing an example of a satellite communication system 100 with power control for satellite terminals, in embodiments. As shown in FIG. 1 a satellite terminal 110 includes a radio 112 for transmitting and receiving communication signals. The transmission power used at radio 112 for the communication process is managed by a power controller 114. Satellite terminal 110 further includes one or more processors 116 for performing various functions in operating satellite terminal 110, such as managing the initiation of ranging processes, selecting at which Symcod rate(s) the ranging should be performed, and others. Satellite terminal 110 also includes one or more memory 118 for storing executable instructions that may be executed by processors 116.

Satellite terminal 110 sends and receives signals with a satellite 120 over a first radio link 122 (represented by double-headed arrows), which sends and receives signals over a second radio link 124 (also represented by double-headed arrows) with a gateway 130. Gateway 130 is connected with a network 140, which can include the Internet, to communicate with servers 150 and other devices. Satellite terminal 110 provides a network connection to one or more client devices 160, such as laptop computers, desktop computers, mobile phones, tablets, and the like.

To transmit data effectively, satellite terminal 110 adjusts the power level of its transmissions to be appropriate for the transmission conditions, such as bandwidth availability, atmospheric conditions, and other factors. As part of the power control, satellite terminal 110 performs a ranging process, which typically involves satellite terminal 110 sending multiple transmissions (e.g., 50 data bursts) at full power, receiving a signal quality measure (e.g., SNR) from gateway 130 for each transmission received and decoded, and then averaging the SNR over for the series of transmissions. Power control may be used in an attempt to maintain a desired SNR at gateway 130 such that the packet error rate for receiving transmissions remains steady and at an acceptable level.

The amount of power needed for a transmission from satellite terminal 110 to be received and decoded correctly at gateway 130 varies based on the symbol rate, modulation type, and the forward error correction (FEC) code rate combination (i.e., the “Symcod rate”). In conventional ranging methods, fully testing each of the different Symcod rates might require ranging at dozens or hundreds of series of data bursts and corresponding signal quality feedback from gateway 130, which would cause considerable delay and use a significant amount of bandwidth in the satellite network, which would become unavailable for transmission of actual user data.

As noted above, an option to improve efficiency in the ranging process is to use single-rate ranging (SRR), in which results from ranging at one Symcod rate are used to estimate the results that would be achieved for other Symcod rates. However, a simple estimation often results in inaccuracies, especially with estimations for a different modulation type than used in the actual Symcod rate that was ranged.

Instead, satellite terminal 110 performs an improved SRR to obtain a ranging curve 170 for a particular Symcod rate. This ranging curve 170 may then be used as the basis to estimate the relative performance of satellite terminal 110 across many or all of the Symcod rates at which satellite terminal 110 transmits data.

In examples, ranging curve 170 may be generated based on factory calibration data, so that specific transmission characteristics of radio 112 within satellite terminal 110 are incorporated into ranging curve 170. For instance, if radio 112 exhibits nonlinear transmission power characteristics, then such nonlinearity may be taken into account in ranging curve 170.

In addition, or as an alternative, once a satellite terminal is placed in use, satellite terminal 110 may calculate its ranging curve 170 based on ranging data accumulated over time, such as based on stored ranging results 172, and/or based on information about transmissions the satellite terminal makes (e.g., for sending user data bursts, including when using less than full power for transmission), such as based on stored transmission results 174. For example, from time to time as verification, satellite terminal 110 may perform ranging for a subset of Symcod rates, or even for a single Symcod rate. Satellite terminal 110 stores the results of these ranging events as stored ranging results 172. Satellite terminal 110 may organize the ranging results with keys or tags to specify the corresponding parameters such as, and not limited to, a timestamp for the ranging, a ranging event identifier, a signal quality measure (e.g., a measure of maximum SNR or energy per symbol to noise power spectral density ratio (“E_{S}/N_{O}”) for a given Symcod rate when transmitting at full power). Similarly, the cumulative ranging data may be acquired through many instances that are spaced out over time, with ranging for each of the combinations of symbol rates and modulation types desired, with the ranging events spread over time (e.g., performing them intermittently or in different sessions over hours, days, weeks, etc.). Processors 116, using software stored in memory 118, may use the stored ranging results 172 to generate ranging curve 170, even if satellite terminal 110 was not provided with factory calibration data.

Further, satellite terminal 110 tracks transmission data during operation and stores the information as stored transmission results 174. Stored transmission results 174 may be used in further refining the power control operations of satellite terminal, such as ranging curve 170 and/or CLPC performed by power controller 114.

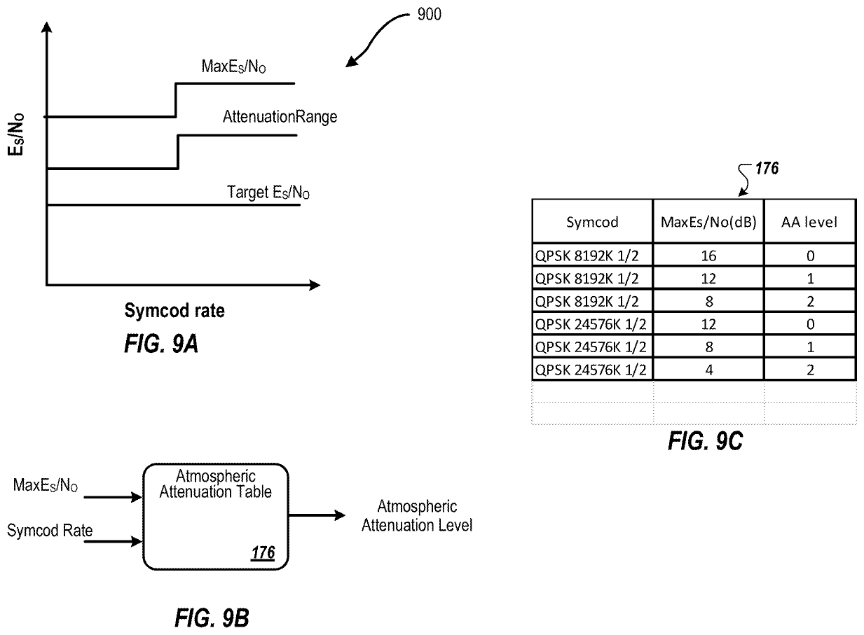

Satellite terminal 110 may also generate and/or store atmospheric attenuation information in an atmospheric attenuation table 176, either as noted during operation of satellite terminal 110 and/or provided from a repository of atmospheric attenuation information. Further details regarding atmospheric attenuation table 176 are discussed below in reference to FIGS. 9A-9C.

Power controller 114 may further use closed-loop feedback control to set and adjust the amount of power that is used for each data transmission. Power controller 114 may be a proportional-integral (PI) or proportional-integral-derivative (PID) controller, optionally with parameter values set using machine learning such as, and not limited to, actor-critic reinforcement learning. For instance, an adaptive PID controller may be used in ranging events such that conventional ranging procedures, particularly using maximum power transmission, is not required and ACI impact may be avoided. In some cases, the adaptive PID controller may be used as a replacement for a legacy Self-Tuning Fuzzy (STF) PID in the closed loop power control processes, as will be described in further detail at an appropriate juncture below.

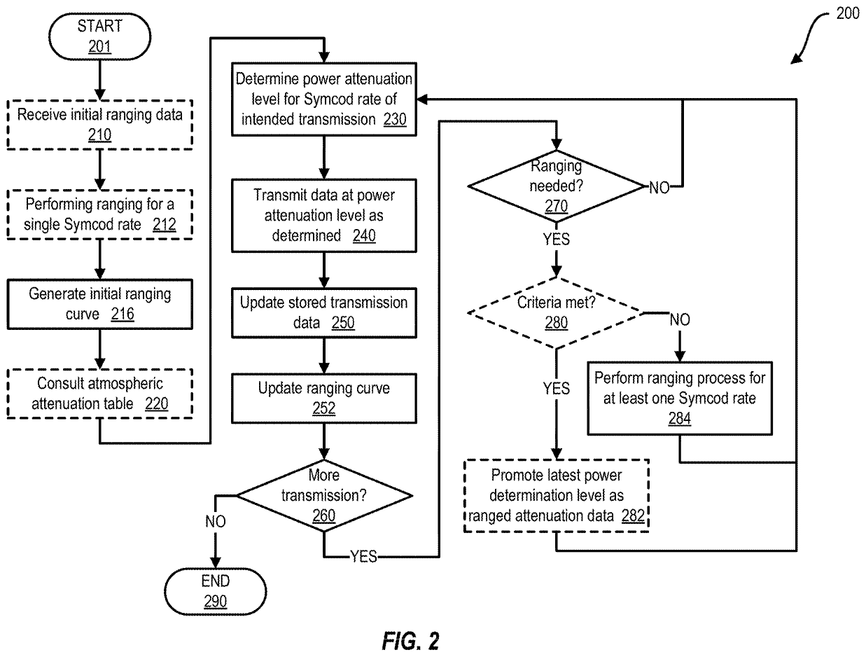

FIG. 2 is a flow diagram illustrating a power control method for use with satellite terminals, in accordance with embodiments. As shown in FIG. 2, a process 200 begins with a start step 201 and proceeds to an optional block 210 to receive initial ranging data. Initial ranging data may include, for example, power calibration files for each satellite terminal as generated at the time of manufacture. Such power calibration files generally include an estimation of the characteristics of the specific radio and/or cables used in the satellite terminal as well as the energy per symbol to noise density ratio (E_{S}/N_{O}) and/or cable noise density ratio (C/N_{O}) so as to account for any nonlinearity in the power transmission behavior of the radio and/or cables. In this way, the effect of modulation types and forward error correction (FEC) rates on the E_{S}/N_{O} may be implicitly taken into account, noting that E_{S}/N_{O} and C/N_{O} are related as:

C/N_{O}=E_{S}/N_{O}+10·log 10(Symbol Rate) [Eq. 1]

For instance, the manufacturer of the satellite terminal generally performs power calibration processes with various frequencies to generate, for example, a file such “pwrcal.dat” supplied to the satellite terminal operator. Similarly, outdoor unit (ODU) cable loss, such as signal degradation caused as a radio frequency signal travels between the radio and an indoor unit, is usually characterized by an installer of the satellite terminal, resulting in a calibration file such as “cblcal.dat” provided to the satellite terminal operator. It is recognized herein that, generally, the adjustments required due to the factory performed, power calibration is approximately 6 dB, while the adjustments indicated by the cable calibration is approximately one-fourth the power calibration, generally approximately 1.5 dB. Thus, the installer workload may be reduced by omitting the ranging calibration for the range of Symcod rates for the cable characterization.

Process 200 proceeds to an optional block 212 to perform a single rate ranging (SRR) process for a single Symcod rate. Based on the initial ranging data received in 210 and/or the SRR result from block 212, an initial ranging curve is generated in a block 216. Optionally, the initial ranging curve may be provided from a database of existing satellite terminal data. As noted above, this initial ranging curve may be used as the basis of the curve fit in determining the appropriate power attenuation for other Symcod rates. Once a ranging curve is built, power attenuation of a rate may be estimated algorithmically, for example, with an algorithm such as represented by a pseudo code below:

```
attenRangedEstimate(rate, baseRate, attenRangedBaseRate)
  attenDot = attenCurve[rate]
  attenBaseRateDot = attenCurve[baseRate] // baseRate is the rate ranged
  shift = attenRangedBaseRate − attenBaseRateDot
  // adjust with curve shifting in y axis
  attenRanged = attenDot + shift
  Return attenRanged
```

wherein attenRangedEstimate is the estimated power attenuation based on the ranging curve, baseRate is the Symcod rate used in the SRR process, attenRangedBaseRate is the attenuation value as generated based on the ranging curve at the Symcod rate used in the SRR process, attenDot is the value of the attenuation at a specific Symcod rate that was not used in the SRR process, and “shift” is the value with which the derived attenuation value should be shifted in order to improve the attenuation estimation.

If an atmospheric attenuation table (e.g., atmospheric attenuation table 176 of FIG. 1) is provided, then it may be consulted in an optional block 220 before process 200 proceeds to determine the power attenuation level for the Symcod rate of the intended data transmission in a block 230. Further details of accounting for atmospheric conditions is described in reference to FIGS. 9A-9C below.

Returning to FIG. 2, data may be transmitted at the power attenuation level so determined in a block 240. The stored transmission data (e.g., stored transmission results 174 of FIG. 1) is updated in a block 250, based on the parameters of the actual data transmission. Similarly, the ranging curve (either the initial ranging curve from block 216 or other stored ranging curves) may be updated in a block 252.

A determination 260 is made whether additional data transmission is required at the same or different Symcod rate. If the answer to determination 260 is YES, then process 200 proceed to a determination 270 whether transmission conditions (e.g., atmospheric conditions, SNR, E_{S}/N_{O} and other measures of transmission) have changed such that an additional implementation of a ranging process is required. If determination 270 results in N_{O}, additional ranging is not needed, then process 200 returns to block 230 to determine the power attenuation level for the Symcod rate of the new data transmission.

If the answer to determination 270 is YES, ranging is needed, then an optional Just-in-Time (JIT) ranging process may be initiated. JIT ranging process involves an optional determination 280 to determine whether the immediately preceding data transmission met certain predetermined criteria. The criteria may include conditions such as, and not limited to, having a zero transmission error rate over a certain number of bursts over a time period, and the measured difference between the target E_{S}/N_{O} and the received E_{S}/N_{O} values from the gateway be less than a threshold value within a predetermined standard deviation. Such criteria may be expressed, for instance, as follows:

transmit error rate=0 in b bursts and t seconds [Eq. 2]

targetEsNo−rxEsNo<n dB,with a standard deviation less than d [Eq. 3]

The received E_{S}/N_{O} values may be received as feedback from the gateway receiving the data transmission. If the criteria are determined to have been satisfied at determination 280, then the power attenuation (“txAtten”) is promoted as the ranged attenuation value for the next transmission. That is, if the preceding transmission met certain criteria, then the power attenuation used with the preceding transmission is used to update the ranging data accordingly, as if a ranging process had been performed. Process 200 then returns to block 230 to determine the appropriate power attenuation level for the Symcod rate of the intended transmission.

If determination 280 results in N_{O}, the predetermined criteria have not been met, then a ranging process is performed for at least one Symcod rate in a block 284, and again process 200 returns to block 230. If the answer to determination 260 is N_{O}, then process 200 is terminated at an end step 290. The JIT ranging process determination may be made algorithmically, for example, by using a process as represented by the pseudo code below to determine whether the power attenuation value used in the previous transmission may be promoted to a ranged power attenuation (“attenRanged”):

```
txAttenPromote(rate, level, txAtten)
  if ( timeSinceRateChanged(rate) > t &&
      burstsSent(rate) > b &&
      txErrorRate(rate) == 0 &&
      (targetEsNo − rxExNo) < n &&
      stdDev( targetEsNo − rxExNo) < d
    )
    replaceAttenRanged(rate, level, txAtten)
    return true
  else
    return false
```

where t is a minimum threshold value for an amount of time, b is a minimum threshold number of bursts, n is a power level in dB, and dis a maximum threshold value for standard deviation.

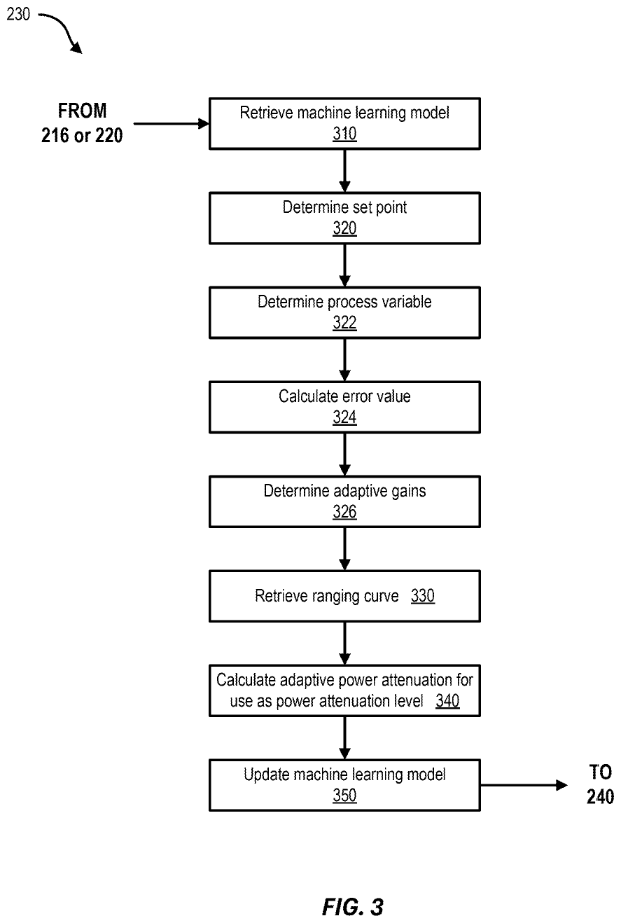

Further details of block 230 to determine the appropriate power attenuation level are illustrated in FIG. 3, which is a flowchart illustrating a portion of the power control method of FIG. 2, in accordance with embodiments. In particular, the flowchart of FIG. 3 illustrates implementation of an adaptive power control process, in which the power controller (e.g., power controller 114 of FIG. 1) is trained to respond to changing transmission conditions based on a machine learning model. For example, when a proportional-integral (PI) or proportional-integral-derivative (PID) controller is used, the controller may be trained to adjust the proportional gains and/or integrative gains on the basis of machine learning models trained on stored ranging results (e.g., stored ranging results 172 of FIG. 1) and/or stored transmission results (e.g., stored transmission results 174 of FIG. 1) as observed during operation of the specific satellite terminal. The machine learning model may be trained, for example, by reinforcement learning processes such as actor-critic reinforcement learning or others. Further, if a PID controller is used, the derivative gain may be excluded from the power control calculations in order to reduce the calculation sensitivity to noise.

As an example, the control output u(t) as a function of time from the power controller (e.g., power controller 114 of FIG. 1) may be expressed as:

u(t)=Kp(t)*(eₜ)+Ki(t)*(e₀+e₁+e₂+. . . +eₜ₋₁) [Eq.4]
where:

e(t)=τ(t)−y(t)=error value [Eq.5]
τ(t)=set point
γ(t)=process variable
Kₚ(t)=adaptive proportional gain
Ki(t)=adaptive integral gain
   Kp(t) and Ki(t) are adaptive gains trained with a machine learning model, as discussed above, to ensure fast response times while maintaining stability of the closed loop power control process.

As an example, FIG. 3 shows an example implementation of block 230 of FIG. 2. As shown in FIG. 3, block 230 follows block 216 or optional block 220, and begins by retrieving a pre-trained machine learning model at a block 310. The machine learning model may be initially provided, for example, by the satellite terminal manufacturer or operator.

The set point t (t) is determined in a block 320, such as based on previous transmission results, specified as a predetermined value in the memory of the satellite terminal, or from an external database. Similarly, the process variable y (t) is determined in a block 322, and the error value is calculated in a block 324. The adaptive gains are also determined from the machine learning model in a block 326.

The current version of the ranging curve is retrieved in a block 330, and the adaptive power attenuation (i.e., u (t)) is calculated in a block 340, using both the ranging curve and the adaptive power calculation. The resulting power control output may be used to update the machine learning model in a block 350, and the process proceeds to block 240 of FIG. 2.

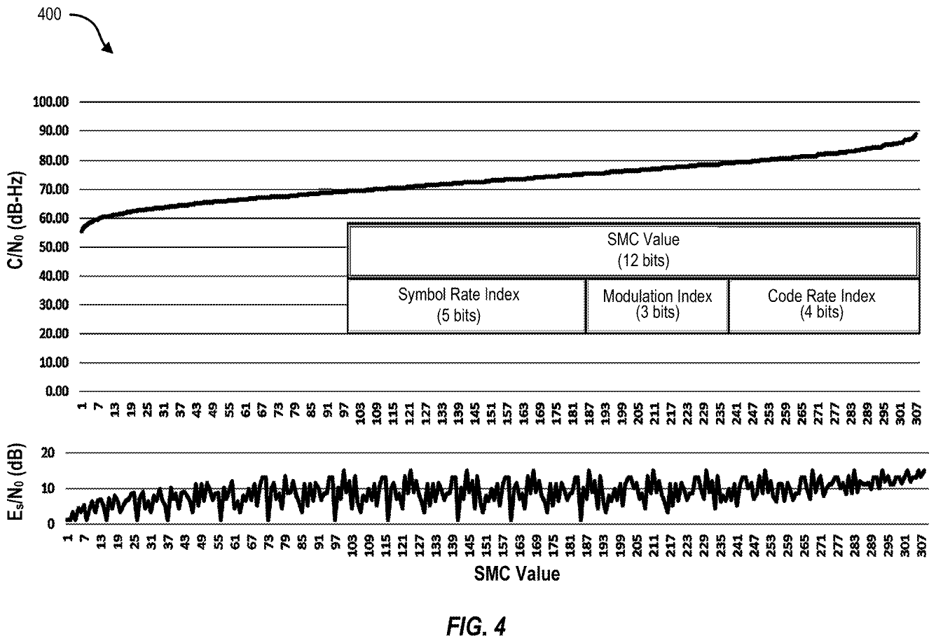

Further details of a multi-segment curve fitting method are illustrated in FIGS. 4-8. To begin, FIG. 4 are graphs illustrating measured cable noise density ratio (C/N_{O}) values and energy per symbol to noise density ratio (E_{S}/N_{O}) as a function of symbol rate index, modulation index, and code rate index (SMC) values over a variety of combinations of symbol rates, modulation types, and forward error correction code rates. Ideally, a complete ranging curve covers the ranging results for all possible combinations of symbol rates and modulation types (i.e., Symcod rates) supported by the satellite terminal. FIG. 4 shows an example of C/N_{O} and E_{S}/N_{O} values over a complete set of SMC values corresponding to 141 Symcod rates. The power for various FEC code rates within a symbol rate/modulation type combination may be estimated algorithmically, for example, using a current per symbol rate ranging algorithm. It takes a significant effort to obtain such a complete set of measurements for every transmission condition and Symcod combination. Thus, a more efficient approach, such as Single Rate Ranging, would be desirable.

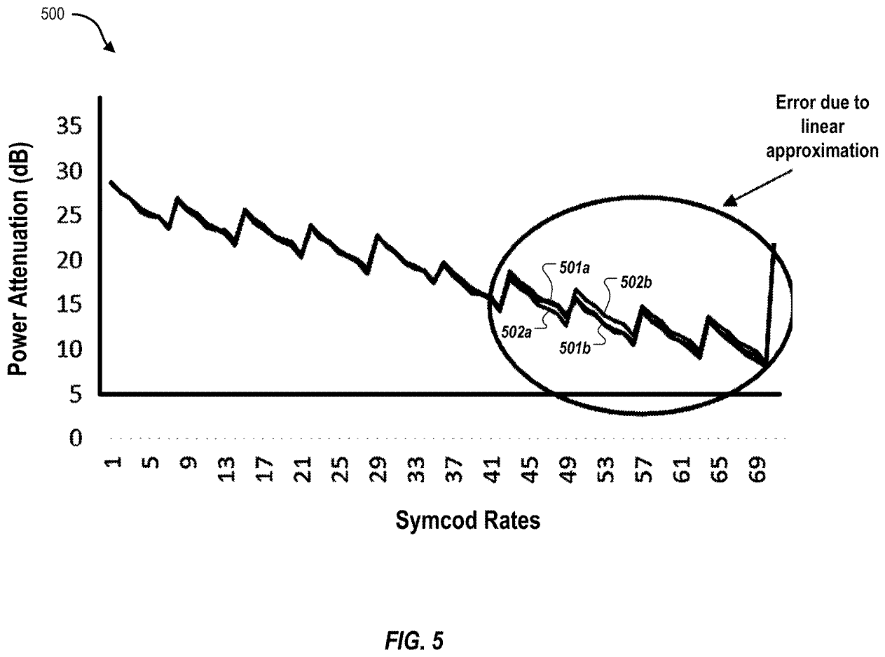

However, SRR is known to introduce inaccuracies during extrapolation to Symcod rates outside of the most robust rate at which the SRR was taken. FIG. 5 is a graph illustrating an example of error that can result from power estimation without curve fitting or other techniques discussed herein. More particularly, FIG. 5 shows a graph 500 plotting the power attenuation in dB over a subset of Symcod rates using conventional extrapolation techniques from SRR, based on linear approximations.

As visible in graph 500, for some Symcod rates, a linear approximation based on single-rate ranging is close to the actual desired attenuation level. However, for certain Symcod rates, the estimations of the power attenuation are inaccurate. For example, approximated attenuation levels indicated as 502a are all lower than the appropriate attenuation level 501a, likely leading to higher error rates for transmission at these Symcod rates. In contrast, approximated attenuation levels 501b are higher than the appropriate attenuation 502b at a different portion of the estimation curve, leading to the satellite terminal using more power than necessary at these Symcod rates.

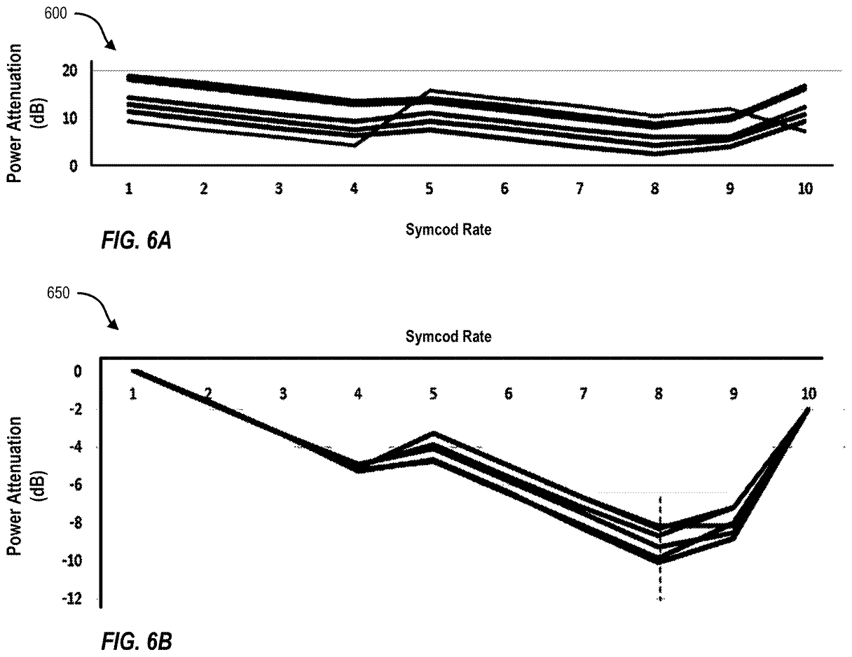

FIGS. 6A and 6B are graphs illustrating examples of ranging curves for several different satellite terminals using a conventional SRR approach. FIGS. 6A and 6B are intended to show how performance can be different for different satellite terminals across a range of combinations of symbol rates, modulation types, and forward error correction code rates. In particular, FIG. 6A shows a comparison of ranging curves for seven different satellite terminals at ten Symcod rates. As visible in FIG. 6A, details of the ranging curves for the seven different satellite terminals can differ significantly at certain Symcod rate ranges. Such differences can lead to increased error rates and undesirable effects in the data transmission from the satellite terminal.

FIG. 6B shows the differences in ranging curves for the seven different satellite terminals, when the ranging curves of FIG. 6A are shifted to an arbitrary origin for comparison. While the differences between the aligned ranging curves are within an approximately 2 dB range, such inaccuracies can still be problematic over time.

As noted above, while the conventional SRR approach allows for increased efficiency, the extrapolation to Symcod rates other than the specific Symcod rate at which the SRR was obtained can lead to inaccurate power control results. To improve the curve fit accuracy even with the SRR approach, the present disclosure provides for generation of the initial ranging curve based on power calibration files containing the measured characteristics of the radio within a given satellite terminal. In this way, the estimation process combines the radio's characteristics with the configured E_{S}/N_{O} and/or C/N_{O} to implicitly account for the effect of modulation types and FEC rates on the E_{S}/N_{O} by using a conversion formula:

C/N_{O}=E_{S}/N_{O}+10 log 10(Symbol Rate)[Eq.6]

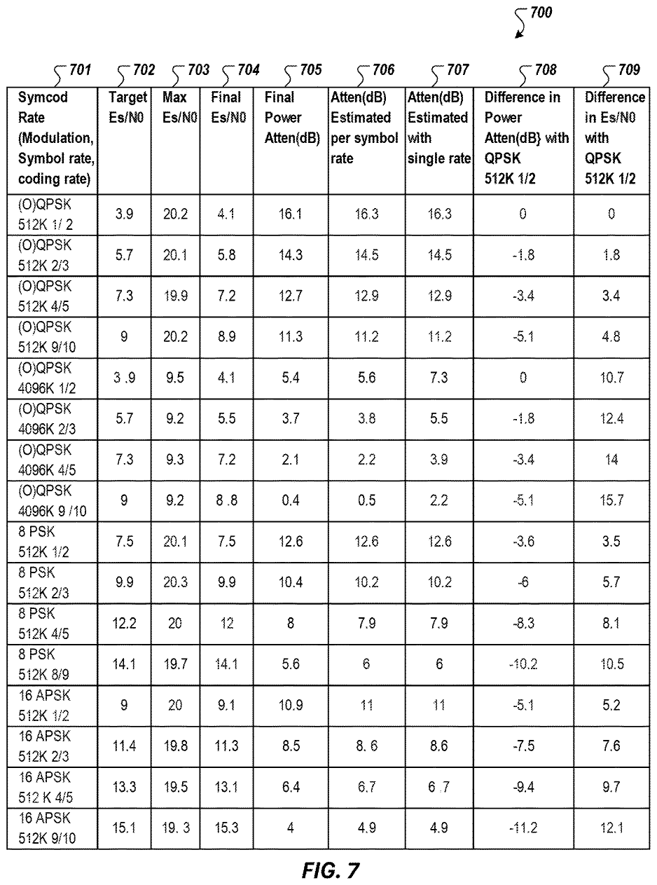

FIG. 7 is a table showing an example of target signal quality measures and other characteristics for a variety of modulation types and code rates, in accordance with embodiments. In particular, FIG. 7 summarizes the power attenuation value as calculated based on a variety of parameters, such as the Symcod rate, the target E_{S}/N_{O} values, and other parameters for different combinations of symbol rate, modulation type, and code rate values. In combination with taking into account the nonlinearity of the transmission behavior of the radio as discussed above, the table in FIG. 7 provides a more accurate comparison of the power attenuation for different Symcod rates.

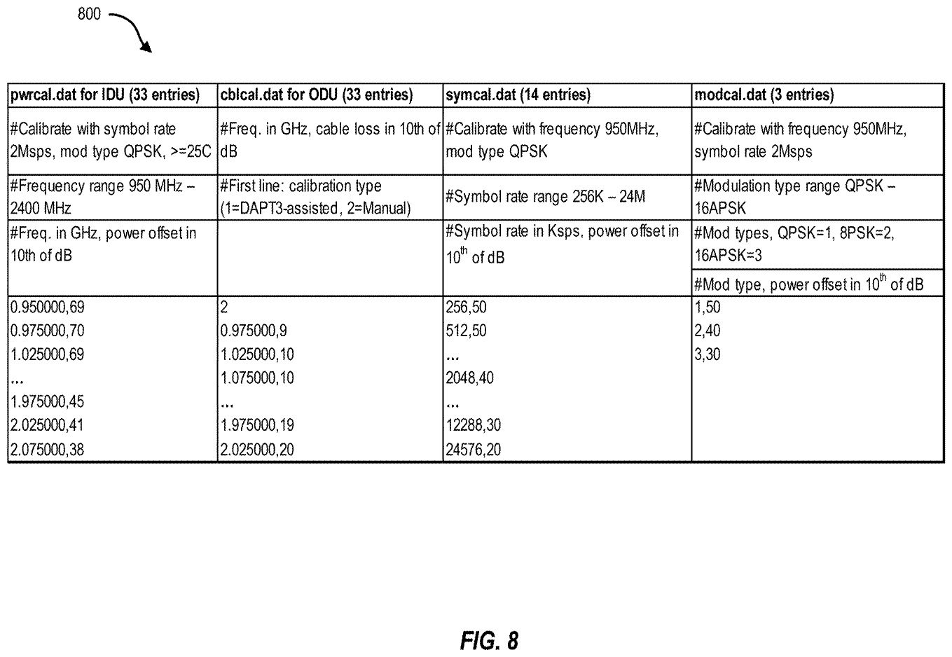

FIG. 8 is a table showing an example of information in calibration files suitable for use in generating the initial ranging curve of a satellite terminal, in accordance with embodiments. As noted above, the initial ranging curve may be generated from the power calibration files as produced for each satellite terminal at the time of manufacture. For instance, the power calibration file for a given indoor unit may be provided as a data file (e.g., “pwrcal.dat” in FIG. 8), while an outdoor unit cable loss calibration with various frequencies may be generated by the installer of the satellite terminal (e.g., “cblcal.dat” in FIG. 8). It is noted that, in certain embodiments since the adjustments prescribed by an inspection of pwrcal.dat are approximately 6 dB, while cblcal.dat yields power adjustments that approximately 4 times less, at around 1.5 dB, then the ranging calibration for the cable portion may be omitted to reduce the workload on the satellite terminal installer.

Examples of the ranging curve calibration files (e.g., “symcal.dat” and “modcal.dat”) for a given satellite terminal are also shown in FIG. 8. The power attenuation offsets in symcal.dat and modcal.dat may have been measured with a factory application programming interface. In the illustrated example, symcal.dat was measured with frequency 950 MHz and Quadrature Phase Shift Keying (QPSK) over a symbol range from 256 kSPS to 24 MSPS. modcal.dat had been generated with frequency of 950 MHz at 2 MSPS, with modulation type ranging from QPSK to 16-ary Amplitude and Phase-Shift Keying (16APSK) modulation.

In the presently described techniques, it is recognized that the ranging curve, which represents power attenuation as a function of Symcod rates, includes multiple line segments. This curve may be estimated, for example, using an algorithm to determine the power attenuation for each available rate for the satellite terminal, based on the factory-calibrated data as derived from symcal.dat and modcal.dat.

For example, a ranged power attenuation value (“attenRanged”) for each of a plurality of Symcod rates may be generated based on the Symcod rate used in the SRR process (“baseRate”), corresponding to a base ranging result (“baseAttenRanged”). For each Symcod rate to be included in a ranging curve (e.g., ranging curve 170 of FIG. 1), a modulation type offset (“modOffset”) and a symbol rate offset (“symOffset”) for that Symcod rate is determined by retrieving the offset values from calibration data of the terminal. Base modulation type offset (“bmodOffset”) and base symbol rate offset (“bsymOffset”) for the base rate used in the single-rate ranging may also be retrieved from the calibration files. The estimated attenuation (“attenEstimated”) may be obtained by starting with a SRR result, baseAttenRanged, and subtracting the difference between the C/N_{O} for the new rate and the C/N_{O} for the base rate used for single-rate ranging. The ranged attenuation for a new Symcod rate (“attenRanged [rate]”) may be obtained by applying further offsets to the estimated attention value, attenEstimated. This technique is expressed with the following pseudo code below:

```
rangingCurveGenerate (baseAttenRanged, baseRate)
  For rate in ratesAvailable
    // the attenuation of rate is estimated from the baseRate
    // Offsets are from calibration files, e.g., symcal.dat and modcal.dat
    modOffset = modOffsetCalibrated[rate]
    symOffset = symOffsetCalibrated[rate]
    bmodOffset = modOffsetCalibrated[baseRate]
    bsymOffset = symOffsetCalibrated[baseRate]
    // mapping to different rate with power attenuation converting
    formulas
    attenEstimated = attenEstimatedAttenGet(baseAttenRanged,
    baseRate, rate)
    // adjust power attenuation with calibration data
    attenRanged[rate] = attenEstimated +
        (modOffset − bmodOffset) + (symOffset − bsymOffset)
  Endfor
attenEstimatedAttenGet(baseAttenRanged, baseRate, rate)
      attenEstimated = baseAttenRanged − (CN0[rate] − CN0[baseRate])
      return attenEstimated
```

In some implementations, the satellite terminal 110 can generate the power attenuation values using one or more of the following equations that can adjust for differences in modulation type, symbol rate, or FEC code rate. The first equation below is for modulation type, the second equation is for symbol rate, and the third is for code rate:

$${P}_{att , m} = {P}_{att , QPSK} + 10 {log}_{10} ( \frac{{R}_{QPSK}}{{R}_{m}} ) \qquad [ Eq . 7 ]$$

$${P}_{att , m} = {P}_{att , n} - 10 {log}_{10} ( \frac{{R}_{m}}{{R}_{n}} ) \qquad [ Eq . 8 ]$$

$${P}_{att , r} = {P}_{att , 1 / 2} + 10 {log}_{10} ( \frac{r}{Reference FEC rate} ) \qquad [ Eq . 9 ]$$

where m represents a modulation type, Quadrature Phase Shift Keying (QPSK) is used as a reference modulation type, Rₘ represents a desired symbol rate and Rₘ represents a reference symbol rate, and r represents a desired forward error correction (FEC) rate.

To allow fast and efficient ranging, the satellite terminal can store information for a ranging curve (e.g., ranging curve 170 of FIG. 1). The satellite terminal can use the ranging measurements for one combination of symbol rate and modulation type with the ranging curve to accurately determine the power level for any of various other combinations of symbol rates and modulation types. The present technique further increases the accuracy of single-rate ranging by using a curve fitting algorithm to indicate relationships between the performance of a terminal for various combinations of symbol rates and modulation types, taking into account the nonlinear behavior of components within the satellite terminal, as discussed above. In this way, a ranging curve can be generated that relates the performance of the various combinations of symbol rates and modulation types (e.g., shows relative performance of each symbol rate and modulation type combination to each other). Once the terminal is deployed, the terminal can perform ranging to determine current performance for one combination of symbol rate and modulation type, then use the relationships indicated by the ranging curve to accurately estimate the performance for any of the other combinations of symbol rate and modulation type on the ranging curve.

Another technique that a terminal can use to perform efficient ranging is to generate ranging from transmissions that are not formally ranging events. For example, during normal communication, the terminal may perform transmissions with certain power levels that achieved desired performance characteristics, such as a low error rate over a period of time. Even though these transmissions were not made at full power for the purpose of ranging, the successful transmission for the power levels used can be used to infer ranging performance or substitute for ranging events. For example, after successful transmissions over at least a minimum period of time, the terminal can save the information about settings used, and the terminal can adjust for the power level used to infer the performance that would be achieved if full power had been used for transmission. Such transmission information may be stored at the satellite terminal (e.g., stored transmission results 174 of FIG. 1). This iteration process increases the amount of data points available for the terminal to use for creating or updating a ranging curve, thus allowing updating of the ranging curve without the need to use time and bandwidth for additional ranging events.

The satellite terminal may also take into account atmospheric attenuation. When a terminal transmits with no power attenuation (e.g., at full power), the primary source of attention is atmospheric attenuation. With feedback from a terrestrial gateway, the terminal can determine a measure of received signal strength, such as its maximum E_{S}/N_{O} (“maxE_{S}/N_{O}”), which may be used as an indicator for the free space loss or atmospheric attenuation level. When transmission is performed at full power and at the same Symcod rate, a lowered signal quality (e.g., SNR or E_{S}/N_{O}) may be primarily attributed to atmospheric attenuation, such that different signal quality levels can indicate different atmospheric conditions. Such data may be accumulated, such as the maximum E_{S}/N_{O} for each Symcod rate under different weather conditions, in the atmospheric attenuation table. Then, the ranging results for any one of the Symcod rates can be used to determine an atmospheric attenuation classification, which can then be used to determine the appropriate characteristics even when using other Symcod rates. When other transmissions are made with the same combination of symbol rate and modulation type and with the same power level, but have lower measures of received signal strength, the difference can be attributed largely to a higher level of atmospheric attenuation.

FIGS. 9A-9C are diagrams illustrating aspects example techniques for detecting and accounting for atmospheric attenuation, in accordance with embodiments. In particular, FIG. 9A shows a graph illustrating shifts in the maximum energy per symbol to noise power spectral density ratio (E_{S}/N_{O}) and ranged attenuation in the presence of atmospheric conditions.

Using various measurements, the satellite terminal can generate and store a table of atmospheric attenuation data (e.g., atmospheric attenuation table 176 of FIGS. 1 and 9B) that indicates, for example, the maximum signal strength measures for each of multiple atmospheric attenuation levels, for each of different combinations of symbol rate and modulation type, as shown in plot 900 of FIG. 9A. This information can be used to calibrate transmission power levels more accurately than with single-rate ranging alone, and to reduce the need for re-ranging when weather patterns change. In other words, historical ranged data are reused instead of re-ranging for changes in atmospheric attenuation.

Later, the terminal can perform ranging for one combination of symbol rate and modulation type, and from the maximum signal strength measure determined, look up the atmospheric attenuation level that is indicated by the atmospheric attenuation table. For example, FIG. 9B is a block diagram illustrating a process of consulting an atmospheric attenuation table in order to generate an atmospheric attenuation level, in accordance with embodiments. As shown in FIG. 9B, the atmospheric attenuation table may be consulted, based on the MaxE_{S}/N_{O} value for the satellite terminal and the Symcod rate for the new transmission, to yield the appropriate atmospheric attenuation level. FIG. 9C is an example atmospheric attenuation table, in accordance with embodiments, indicating the Symcod rate, MaxE_{S}/N_{O} values, and the corresponding atmospheric attenuation (“AA”) value. In this way, the satellite terminal may use the determined level of atmospheric attenuation to look up or calculate the expected signal strength or other performance characteristics needed for making transmissions at any of the other combinations of symbol rate and modulation type.

Each entry in atmospheric attenuation table 176 in FIG. 9C corresponds to a different combination of a Symcod rate and a maximum E_{S}/N_{O} value. Each Symcod rate may occur multiple times, with different maximum E_{S}/N_{O} values to correspond to different weather conditions. Each maximum E_{S}/N_{O} value can indicate a minimum threshold at which to find the corresponding atmospheric attenuation level. If there is a maximum E_{S}/N_{O} (e.g., “maxES/N_{O}”) during ranging that is above 12 dB and less than 16 dB, then the atmospheric attenuation level for the ranged data may be determined to be 1. If the ranged result was 16 dB or higher, that may indicate an atmospheric attenuation level of 0, which represents a clear sky.

For performing closed-loop power control, the ranged power attenuation (“attenRanged”) is retrieved based on the Symcod rate and the atmospheric attenuation level. For example, accumulated historical ranged data can be organized by timestamp, event identifier, atmospheric attenuation level, and Symcod rate. A given row defined by these four values can include ranged data for those conditions, such as a maximum E_{S}/N_{O}, a ranged power attenuation value, and so on.

The atmospheric attenuation table may be updated each time the results of ranging are received. For example, the atmospheric attenuation table may be initialized with an entry representing a default atmospheric attenuation level of zero, and will return ranged power attenuation for the clear sky level (e.g., level 0) for any mapping request, until entries for additional atmospheric attenuation levels are added after more ranged data becomes available. In some implementations, data from the atmospheric attenuation table may be shared among satellite terminals if the types of values (e.g., maxE_{S}/N_{O}) used in the table are independent of the board-specific characteristics of the outdoor unit of the satellite terminal.

In some implementations, atmospheric attenuation table 176 may additionally or alternatively be used to handle variation due to noise floor level changes at gateway 130 and/or changes in SNR arising from satellite terminal 110 being located at the edge of a satellite beam. For example, detecting a reduced maximum E_{S}/N_{O} for a Symcod rate, for reasons in addition to or instead of atmospheric attenuation, and still be used to determine an attenuation classification or category that allows a ranged power attenuation to be calculated for any of multiple Symcod rates without having to perform ranging for those specific Symcod rates.

As discussed above, a curve fitting algorithm, with a ranging curve 170 generated based on factory calibration, can enable a satellite terminal 110 to perform single rate ranging in a way that achieves more accurate power attenuation estimations. For satellite terminals already installed in the field, techniques such as accounting for atmospheric attenuation levels, accumulating ranging data over time, and selectively promoting power attenuation levels used for transmissions of user data can be used by a satellite terminal to learn, derive, and refine ranging curve. These techniques can be combined with an adaptive PID power controller to further ranging with lower time and lower power expenditure and to increase closed-loop power control performance.

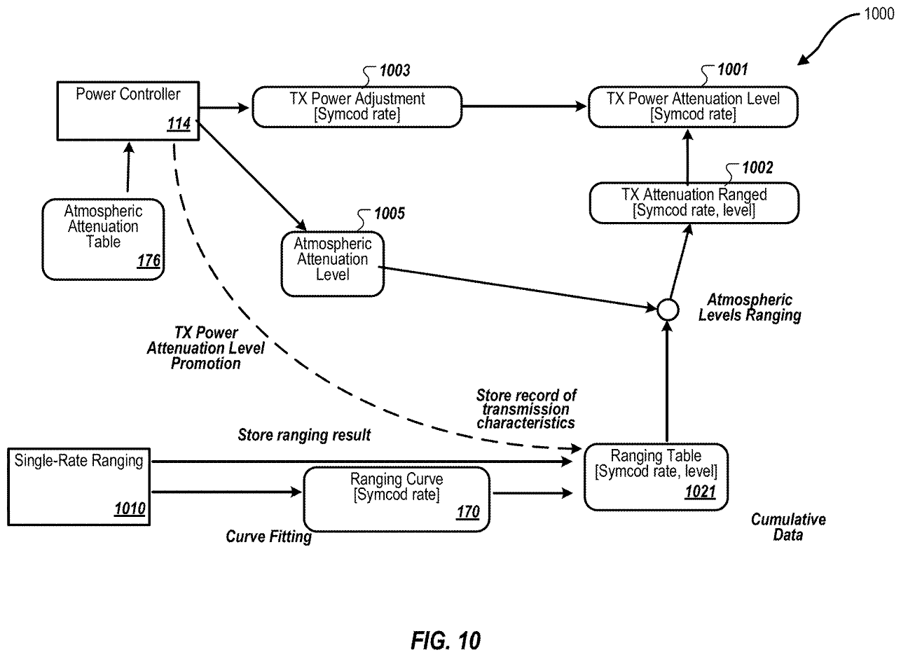

FIG. 10 is a block diagram illustrating an example of techniques that can be used for power control in satellite terminals, in accordance with embodiments. As shown in FIG. 10, a diagram 1000 illustrates the various interactions and/or calculations that may be used to determine a transmission power level to use, as well as techniques to update the records or data for use in determining transmission power levels in the future. The example includes operation of the power controller and the use of single-rate ranging, along with other techniques.

As an overview, the transmission power level to be used for making a transmission of a data burst is labeled TX power attenuation 1001. In the illustrated example, TX power attenuation 1001 value may represent a setting that specifies an amount by which satellite terminal 110 reduces its power output, with respect to a given, maximum power level that can be used for transmission.

The transmission power level or TX power attenuation 1001 may be based on two values, a ranged power attenuation 1002 and a power adjustment 1003, which may be determined by power controller 114. Ranged power attenuation 1002 may serve as a starting point or initial value for transmission power, and power controller 114 may generate an output that adjusts the power level up or down from ranged power attenuation 1002.

Satellite terminal 110 may use single-rate ranging (shown as block 1010) to quickly and efficiently determine ranging data for a single Symcod rate. From the ranging results for the single Symcod rate, satellite terminal 110 uses ranging curve 170 to extrapolate the properties or characteristics for another Symcod rate. For example, after obtaining ranging results for a Symcod rate 1, satellite terminal 110 may use ranging curve 170 to determine a corresponding ranged power attenuation for a Symcod rate 2. For example, relationship between Symcod rate 1 and Symcod rate 2 may indicate an adjustment factor with which to scale the ranged power attenuation for Symcod rate 1 up or down, according to ranging curve 170. It is noted herein that the resulting ranged power attenuation may not account for varying atmospheric conditions, as discussed above.

The ranging results from single-rate ranging 1010 may also be stored in a ranging table 1021. In this way, the results from multiple ranging events may be accumulated for use in creating or updating ranging curve 170. Thus, results from ranging processes that are spaced out over hours, days, or weeks, or longer, may be stored and used to create or update ranging curve 170 for a given satellite terminal.

Power levels used for transmission of user may also be promoted so that they are used in place of or are used to supplement ranging results, as discussed above with respect to FIG. 2. Satellite terminal 110 may apply a set of predetermined criteria to determine when a series of transmissions reaches standards for consistency and signal quality for at least a minimum amount of time or amount of transmission. When satellite terminal 110 determines that the criteria are satisfied, it may store a record describing the transmission characteristics (e.g., timestamp, power attenuation level used for transmission, signal quality measures reported by gateway 130, etc.). In some implementations, satellite terminal 110 may normalize the records to account for one or more transmissions using less than the full power often used for ranging, so that the stored records report characteristics comparable with the results from transmissions made using full power.

Satellite terminal 110 may also consult atmospheric attenuation table 176 to make adjustments based on levels of attenuation that are currently being experienced under given atmospheric conditions. For example, using atmospheric attenuation table 176, an atmospheric attenuation level 1005 resulting from current weather conditions can be determined. An atmospheric attenuation level 1005 may be stored in the record for the ranging result in a ranging table 1021. In addition, atmospheric attenuation level 1005 may be used to adjust the process of calculating ranged power attenuation 1002. For example, satellite terminal 110 may use the ranging results from single-rate ranging 1010 to look up, using atmospheric attenuation table 176, an atmospheric attenuation level 1005 corresponding to current conditions. Atmospheric attenuation table 176 may store information indicating signal quality levels corresponding to different classifications or categories of atmospheric attenuation and/or other sources of external attenuation, allowing a measure of signal quality determined for a Symcod rate to be used to look up an appropriate classifications or categories. Satellite terminal 110 then uses the category or classification in the process of determining ranged power attenuation 1002. For example, satellite terminal 110 may look up a value of power attenuation corresponding to the determined category or classification, or satellite terminal 110 may use the category or classification to adjust a level of power attenuation determined using ranging curve 170.

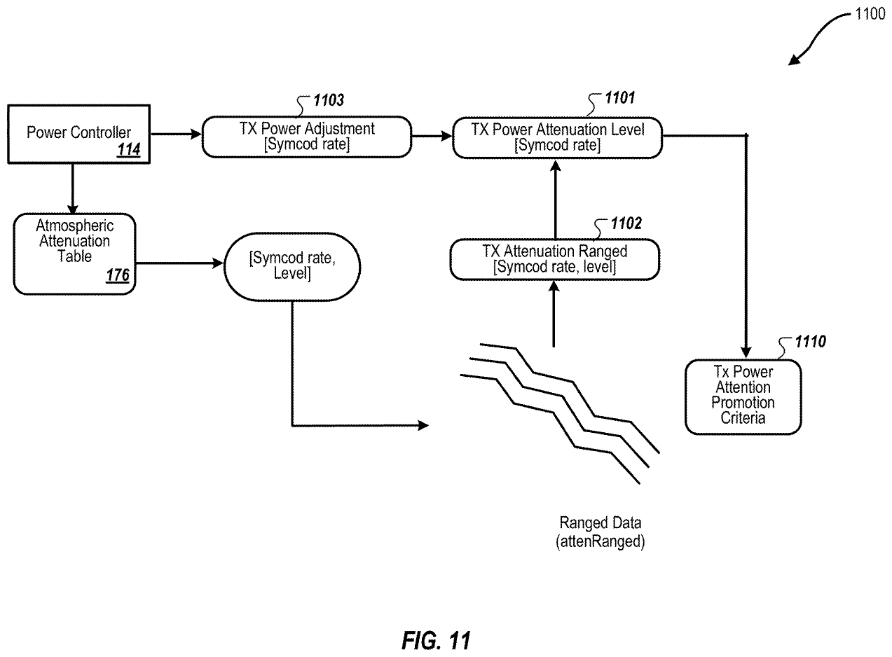

FIG. 11 is a block diagram illustrating an example of techniques for using information about transmissions made by a satellite terminal to create or update a ranging curve, in accordance with embodiments. Similar to FIG. 10, a diagram 1100 of FIG. 11 shows how a transmission power attenuation 1101 applied for transmission at a particular Symcod rate may be determined based on a ranged power attenuation 1102 as adjusted by a power adjustment 1103 determined by power controller 114. Ranged power attenuation 1102 may be based on the Symcod rate for transmission as well as an atmospheric attenuation level determined for the current weather conditions. Atmospheric attenuation table 176 may again be used to determine the atmospheric attenuation level from the recent ranging results.

As discussed above with respect to FIG. 2, satellite terminal 110 may use a set of power attenuation promotion criteria 1110 to determine whether the power attenuation determined in a situation should be used as if it provided information comparable to ranging results. Attenuation promotion criteria 1110 may specify a set of criteria or rules to evaluate the characteristics of transmissions and the corresponding feedback received from gateway 130. For example, the criteria may include a specification that a transmission error rate of zero (or other maximum threshold) is achieved over a predetermined number of data bursts transmitted and/or over at least a predetermined minimum number of seconds. In addition, the criteria may specify that the target E_{S}/N_{O} minus the received E_{S}/N_{O} is less than a maximum threshold, and that the standard deviation of this difference is less than a predetermined maximum value, in order to ensure that transmission properties were sufficiently consistent. The average and standard deviation of for received E_{S}/N_{O} and E_{S}/N_{O} feedback from gateway 130 may also be saved for future reference. Ranging curve 170 can be repeatedly refined with this technique by increasing the quantity and quality of ranged data available for ranging curve 170.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method of controlling transmission power of a satellite terminal, the method comprising:
storing, by the satellite terminal, ranging curve data indicating relative performance of the satellite terminal for a plurality of combinations of symbol rates and modulation types;
performing, by the satellite terminal, a ranging process to determine a first performance measure for the satellite terminal for a first combination of symbol rate and modulation type;
calculating, by the satellite terminal, a second performance measure for the satellite terminal for a second combination of symbol rate and modulation type, the second combination being different from the first combination, wherein the second performance measure is calculated based on the first performance measure and the ranging curve data;
determining, by the satellite terminal, a power level for transmission by the satellite terminal at the second combination based on the second performance measure; and
transmitting, by the satellite terminal, data in a satellite communication network at the second combination using the power level as determined.

2. The method of claim 1, wherein the ranging curve data is based on power calibration measurements that indicate measured characteristics of one or more of a radio and a cable of the satellite terminal.

3. The method of claim 2, wherein the ranging curve data exhibits nonlinear behavior, and calculating the second performance measure further comprises using the ranging curve data in compensating for the nonlinear behavior.

4. The method of claim 1, wherein:
the ranging curve data is based on results of ranging performed by the satellite terminal for each one of a plurality of combinations of symbol rates and modulation types, and
the ranging is performed over time across a plurality of sessions of use for one or more of the plurality of combinations.

5. The method of claim 1, further comprising:
storing, by the satellite terminal, an atmospheric data table that relates atmospheric attenuation levels with a plurality of performance measures for the satellite terminal,
wherein determining the power level further comprises considering the atmospheric data table.

6. The method of claim 5, wherein:
the atmospheric data table includes indications of a plurality of levels of signal quality and corresponding levels of atmospheric attenuation for the first combination and the second combination, and
calculating the second performance measure comprises:
determining a specific level of atmospheric attenuation based on the first performance measure and the atmospheric data table; and
using the specific level of atmospheric attenuation and the atmospheric data table to determine the second performance measure.

7. The method of claim 5, further comprising:
measuring a signal quality of data transmission from the satellite terminal at one or more time points, and
updating the atmospheric data table based on the signal quality as measured at the one or more time points.

8. The method of claim 1, further comprising:
determining additional performance measures of the satellite terminal for transmission outside of the ranging process; and
updating the ranging curve data based on the additional performance measures,
wherein the additional performance measures include transmission characteristics obtained using a transmission power level that is less than a full power level of a radio of the satellite terminal.

9. The method of claim 1, wherein determining the power level comprises using a controller based on one or more parameters determined using a machine learning model.

10. The method of claim 9, wherein:
the controller is one of a proportional-integral (PI) controller and a proportional-integral-derivative (PID) controller, and
the one or more parameters for the controller are determined using reinforcement learning.

11. A satellite terminal comprising:
a transmitter;
a data storage device storing ranging curve data indicating relative performance of the satellite terminal for a plurality of combinations of symbol rates and modulation types; and
a control system comprising:
one or more processors, and
one or more machine-readable media storing executable instructions that, when executed by the one or more processors, cause the satellite terminal to at least:
perform a ranging process to determine a first performance measure for the satellite terminal for a first combination of symbol rate and modulation type;
calculate a second performance measure for the satellite terminal for a second combination of symbol rate and modulation type, the second combination being different from the first combination, wherein the second performance measure is calculated based on the first performance measure and the ranging curve data;
determine a power level for transmission by the satellite terminal at the second combination based on the second performance measure; and
transmit data in a satellite communication network at the second combination using the power level as determined.

12. The satellite terminal of claim 11, wherein the ranging curve data is based on power calibration measurements that indicate measured characteristics of one or more of a radio and a cable of the satellite terminal.

13. The satellite terminal of claim 12, wherein the ranging curve exhibits nonlinear behavior, and calculating the second performance measure further comprises using the ranging curve data in compensating for the nonlinear behavior.

14. The satellite terminal of claim 11, wherein:
the ranging curve data is based on results of ranging performed by the satellite terminal for each one of a plurality of combinations of symbol rates and modulation types, and
the ranging is performed over time across a plurality of sessions of use for one or more of the plurality of combinations.

15. The satellite terminal of claim 11, wherein the executable instructions further cause the satellite terminal to:
store an atmospheric data table that relates atmospheric attenuation levels with a plurality of performance measures for the satellite terminal,
wherein determining the power level further comprises considering the atmospheric data table.

16. The satellite terminal of claim 15, wherein:
the atmospheric data table includes indications of a plurality of levels of signal quality and corresponding levels of atmospheric attenuation for the first combination and the second combination, and
calculating the second performance measure comprises:
determining a specific level of atmospheric attenuation based on the first performance measure and the atmospheric data table; and
using the specific level of atmospheric attenuation and the atmospheric data table to determine the second performance measure.

17. The satellite terminal of claim 15, wherein the executable instructions further cause the satellite terminal to:
measure a signal quality of data transmission from the satellite terminal at one or more time points, and
updating the atmospheric data table based on the signal quality as measured at the one or more time points.

18. The satellite terminal of claim 11, wherein the executable instructions further cause the satellite terminal to:
determine additional performance measures of the satellite terminal for transmission outside of the ranging process, and
update the ranging curve data based on the additional performance measures,
wherein the additional performance measures include transmission characteristics obtained using a transmission power level that is less than a full power level of a radio of the satellite terminal.

19. The satellite terminal of claim 11, wherein determining the power level comprises using one of a proportional-integral (PI) controller and a proportional-integral-derivative (PID) controller based on one or more parameters determined using a machine learning model.

20. One or more non-transitory machine-readable media storing executable instructions that, when executed by one or more processors of a satellite terminal, cause the satellite terminal at least:
store ranging curve data indicating relative performance of the satellite terminal for a plurality of combinations of symbol rates and modulation types;
perform a ranging process to determine a first performance measure for the satellite terminal for a first combination of symbol rate and modulation type;
calculate a second performance measure for the satellite terminal for a second combination of symbol rate and modulation type, the second combination being different from the first combination, wherein the second performance measure is calculated based on the first performance measure and the ranging curve data;
determine a power level for transmission by the satellite terminal at the second combination based on the second performance measure; and
transmit data in a satellite communication network at the second combination using the power level as determined.
